(19) United States
(12) Patent Application Publication
(10) Pub. No.: US 2016/0158103 A1
(43) Pub. Date: Jun. 9, 2016

(54) METHOD FOR HANDLING MEDICINAL AGENT CONTAINER

(71) Applicant: TAKAZONO TECHNOLOGY INCORPORATED, Hirakata-shi, Osaka (JP)

(72) Inventors: Fujio Ohsumi, Hirakata-shi, Osaka (JP); Akihito Isaka, Hirakata-shi, Osaka (JP); Masashi Kitani, Hirakata-shi, Osaka (JP)

(73) Assignee: TAKAZONO TECHNOLOGY INCORPORATED, Hirakata-shi, Osaka (JP)

(21) Appl. No.: 14/906,336

(22) PCT Filed: Jul. 22, 2013
(86) PCT No.: PCT/JP2013/069809

§ 371 Date: Jan. 20, 2016

(51) Int. Cl. A61J 1/16; B65B 53/00; B65B 43/42; A61J 1/20; B65B 7/16

(52) U.S. Cl. CPC A61J 1/16; A61J 1/20; B65B 7/161; B65B 43/42; B65B 53/00

(57) ABSTRACT

There is provided a method for handling a medicinal agent container that allows reduction of the time and effort of an operator handling the medicinal agent container. The method for handling a medicinal agent container includes the steps of: setting a container in a container holding body capable of holding a plurality of containers, the container being capable of being filled with a medicinal agent; filling the medicinal agent of interest into the container held by the container holding body; sealing the container; and wrapping the container held by the container holding body and the container holding body into one package.

### TECHNICAL FIELD

The present invention relates to a method for handling a medicinal agent container into which a medicinal agent is filled.

### BACKGROUND ART

With regard to a device for filling a medicinal agent into a container, there has been conventionally proposed a medicinal agent feeder including: a tablet case made of resin and having a discharge drum for discharging a medicinal agent from a housing container for the medicinal agent; and a chute made of resin, for directly receiving the medicinal agent discharged from the tablet case and guiding the medicinal agent toward the front side (refer to, for example, Japanese Patent Laying-Open No. 2002-291845 (PTD 1)).

### CITATION LIST

### Patent Document

### PTD 1: Japanese Patent Laying-Open No. 2002-291845

### SUMMARY OF INVENTION

### Technical Problem

According to the medicinal agent feeder described in Japanese Patent Laying-Open No. 2002-291845 (PTD 1), an operator needs to manually bring the container to underneath a chute outlet one by one when filling the medicinal agent into the container, which required time and effort.

The present invention has been made in light of the aforementioned problem, and a main object of the present invention is to provide a method for handling a medicinal agent container that allows reduction of the time and effort of an operator handling the medicinal agent container.

### Solution to Problem

A method for handling a medicinal agent container according to the present invention includes the steps of: setting a container in a container holding body capable of holding a plurality of containers, the container being capable of being filled with a medicinal agent; filling the medicinal agent of interest into the container held by the container holding body; sealing the container; and wrapping the container held by the container holding body and the container holding body into one package.

In the method, in the step of filling, by a conveyance device for conveying the container holding body, the container holding body may be moved to a supply position at which the medicinal agent can be supplied to the container held by the container holding body.

In the method, in the step of wrapping, the container and the container holding body may be shrink-wrapped.

The method may further include the step of shipping the container and the container holding body wrapped into one package.

In the method, in the step of setting, more than one container may be set in the container holding body.

### Advantageous Effects of Invention

According to the method for handling a medicinal agent container of the present invention, the time and effort of an operator handling the medicinal agent container can be reduced.

### BRIEF DESCRIPTION OF DRAWINGS

FIG. 1 is a flowchart showing an outline of a method for handling a medicinal agent container.

FIG. 2 is a perspective view of a container holding body.

FIG. 3 is a perspective view showing a state in which the containers have been set in the container holding body shown in FIG. 2.

FIG. 4 is a side view showing a schematic configuration of a medicinal agent filling device.

FIG. 5 is a partial cross-sectional view showing a state in which the container holding body approaches a first supply position.

FIG. 6 is a partial cross-sectional view showing a state in which the container holding body is located at the first supply position.

FIG. 7 is a partial cross-sectional view showing a state in which the container holding body approaches a second supply position.

FIG. 8 is a partial cross-sectional view showing a state in which the container holding body is located at the second supply position.

FIG. 9 is a partial cross-sectional view showing a state in which the container holding body approaches a third supply position.

FIG. 10 is a partial cross-sectional view showing a state in which the container holding body is located at the third supply position.

FIG. 11 is a partial cross-sectional view showing a state in which the container holding body leaves the supply position.

FIG. 12 is a side view showing a state immediately before one container is sealed.

FIG. 13 is a side view showing a state in which one container has been sealed.

FIG. 14 is a side view showing a state in which all containers have been sealed.

FIG. 15 is a side view showing a schematic configuration of a wrapping device.

FIG. 16 is a side view showing the container holding body after a film is applied.

FIG. 17 is a side view showing the container holding body after wrapping is completed.

FIG. 18 is a view schematically showing packing and shipment of the container holding body.

### DESCRIPTION OF EMBODIMENTS

An embodiment of the present invention will be described hereinafter with reference to the drawings, in which the same or corresponding portions are denoted by the same reference numerals and description thereof will not be repeated.

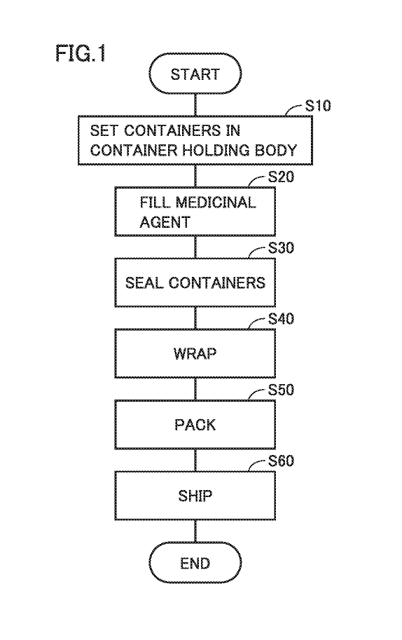

FIG. 1 is a flowchart showing an outline of a method for handling a medicinal agent container. Referring to FIG. 1 and the following figures as required, the method for handling the medicinal agent container of the present embodiment will be described. In the handling method of the present embodiment, containers are first set in a container holding body in step (S10) as shown in FIG. 1.

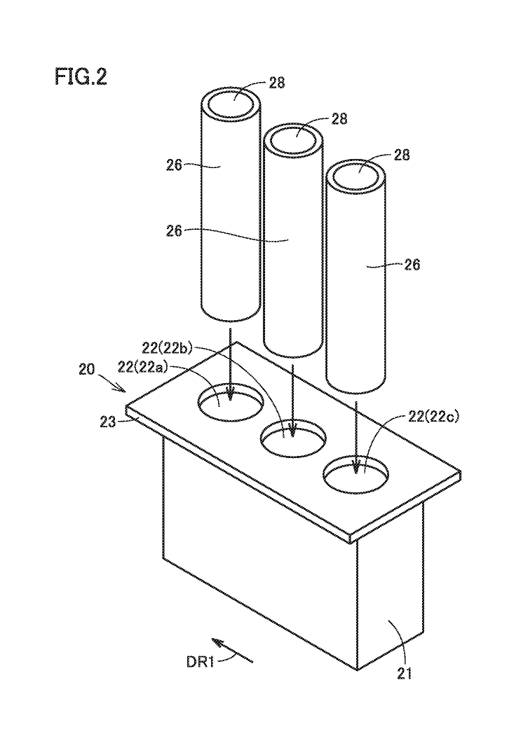

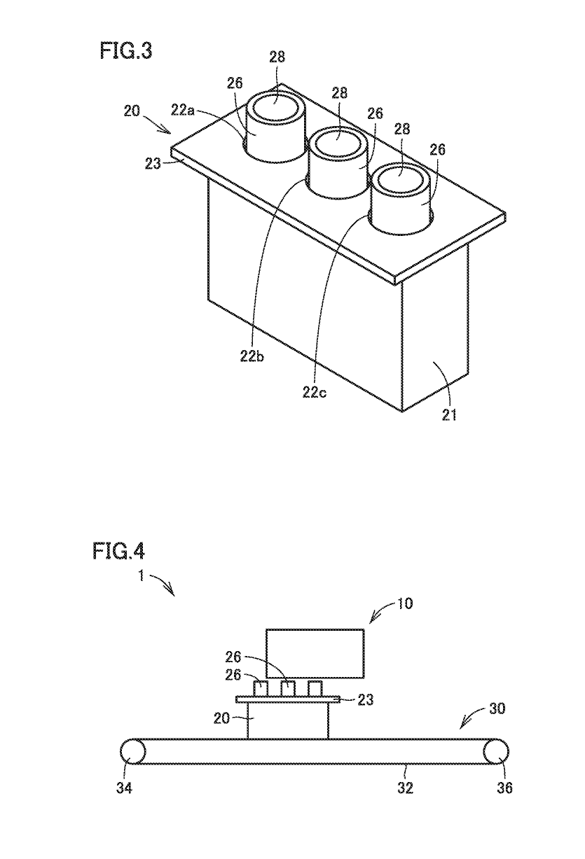

FIG. 2 is a perspective view of a container holding body 20. FIG. 3 is a perspective view showing a state in which containers 26 have been set in container holding body 20 shown in FIG. 2. Container 26, which is a medicinal agent container into which a medicinal agent is filled in the present embodiment, is a substantially cylindrical vial bottle. On the upper side of each container 26, an upper opening 28 that causes the inside and the outside of container 26 to communicate with each other is formed. As long as the medicinal agent of interest can be filled into container 26, the shape of container 26 is not limited to the substantially cylindrical shape. For example, container 26 may have a rectangular box-like shape, or container 26 having another arbitrary shape may be used.

Container holding body 20 has a plurality of holding sections 22, each of which can hold container 26. One holding section 22 holds one container 26, and container holding body 20 having the plurality of holding sections 22 is provided so as to be capable of holding a plurality of containers 26 as a whole. FIG. 2 shows a conveyance direction DR1 of container holding body 20 by a conveyance device 30 described below. The plurality of holding sections 22 are formed to be arranged in the movement direction of container holding body 20. Container holding body 20 may be formed to have a shape that can hold both substantially cylindrical container 26 and the box-like container.

Container holding body 20 has a main body portion 21 provided with the plurality of holding sections 22, and a flange portion 23 protruding laterally from main body portion 21. Main body portion 21 has a substantially rectangular box-like outer shape. Flange portion 23 is provided such that a flat plate projects laterally with respect to main body portion 21. Flange portion 23 is provided so as to be continuous to an upper end of main body portion 21. Flange portion 23 is provided at an end of main body portion 21 on the side where containers 26 are fitted into holding sections 22.

Container holding body 20 is made of resin and is formed by die molding of the resin material. A die used at the time of molding of container holding body 20 is formed to have a shape corresponding to both main body portion 21 and flange portion 23, so that main body portion 21 and flange portion 23 are integrally molded in one process. Flange portion 23 may be formed as a member different from main body portion 21 and may be provided so as to be attachable/detachable to/from main body portion 21.

In container holding body 20 shown in FIG. 2, the interior space of main body portion 21 is divided into three sections, and each of the three sections is provided so as to be capable of housing container 26. As a result, container holding body 20 is provided with three holding sections 22a, 22b and 22c. Holding section 22 (22a, 22b, 22c) is formed to have a circular shape in planar view so as to be capable of housing substantially cylindrical container 26. Three openings corresponding to holding sections 22a, 22b and 22c are formed in container holding body 20 so as to be capable of receiving containers 26. Flange portion 23 is provided on the side of main body portion 21 where the three openings corresponding to holding sections 22a, 22b and 22c are formed.

Container 26 is fitted into holding section 22 along the arrow direction shown in FIG. 2, via the opening formed in container holding body 20. As a result, container 26 is set in container holding body 20, and as shown in FIG. 3, container 26 is held by container holding body 20. In the present embodiment, containers 26 are set in all of the three holding sections formed in container holding body 20, and in FIG. 3, three containers 26 are held by container holding body 20.

The plurality of containers 26 are arranged in conveyance direction DR1 of container holding body 20 conveyed by conveyance device 30, and are held by container holding body 20. With container 26 being held by container holding body 20, container 26 extends from the inside of container holding body 20 through the aforementioned opening to the outside above container holding body 20. With container 26 being held by container holding body 20, an upper end of container 26 is arranged outside container holding body 20.

The work for setting containers 26 in container holding body 20 may be performed manually, or may be performed automatically by using a device for the setting work.

When the setting of containers 26 in container holding body 20 is completed, then in step (S20) shown in FIG. 1, the medicinal agent is filled into each container 26. FIG. 4 is a side view showing a schematic configuration of a medicinal agent filling device 1. Medicinal agent filling device 1 is a device for automating the work for filling, into container 26, a solid medicinal agent such as a tablet or a capsule, or a medicinal agent packaged individually according to dosage unit. Medicinal agent filling device 1 includes a supply device 10 for supplying the medicinal agent of interest to container 26, and conveyance device 30 for conveying container holding body 20 that holds containers 26.

Supply device 10 has medicinal agent cassettes that house various types of medicinal agents according to type. The medicinal agent cassette is provided in supply device 10 in a freely attachable/detachable manner. Supply device 10 may be a device that can simultaneously hold a plurality of medicinal agent cassettes such as, for example, 128 or 256 medicinal agent cassettes. In this case, a plurality of medicinal agents can be easily dispensed from supply device 10 according to type, and thus, in accordance with a prescription including a plurality of medicinal agents, the dispense of the medicinal agents can be completed in a short time. Alternatively, supply device 10 may be configured such that supply device 10 can hold one medicinal agent cassette and the user using the device replaces a necessary medicinal agent cassette as the need arises. In this case, supply device 10 can be reduced in size, and thus, cost reduction and space savings of supply device 10 can be achieved.

A discharge port from which the medicinal agent is discharged is provided on the bottom of supply device 10. The medicinal agent dispensed from the medicinal agent cassette is discharged from the discharge port and falls, and is supplied to container 26.

Conveyance device 30 moves container 26 held by holding section 22 of container holding body 20 to a position at which the medicinal agent can be supplied from supply device 10 to container 26. Conveyance device 30 conveys container holding body 20, and thereby, container 26 moves under supply device 10. When container holding body 20 holds a plurality of containers 26, conveyance device 30 sequentially moves the plurality of containers 26 to the position at which the medicinal agent can be supplied from supply device 10, and temporarily stops container holding body 20 at this position to supply the medicinal agent to container 26.

With container 26 being arranged at an appropriate position where upper opening 28 of container 26 faces the discharge port, the medicinal agent falls from the discharge port of supply device 10 and is filled into container 26. The medicinal agent falling from supply device 10 passes through upper opening 28 and enters into container 26, and is received by container 26. The medicinal agent is supplied from supply device 10 to container 26, and thus, an appropriate quantity of medicinal agent is filled into container 26.

Conveyance device 30 shown in FIG. 4 is a known belt conveyor having a belt 32 and a pair of pulleys 34 and 36. Container holding body 20 is placed on a placement surface on the upper side of belt 32. By movement of belt 32 with rotational motion of pulleys 34 and 36, container holding body 20 placed on belt 32 is conveyed in conveyance direction DR1. Conveyance device 30 in the present embodiment conveys, in conveyance direction DR1, container holding body 20 placed on belt 32. Conveyance direction DR1 is the direction from one to the other of the pair of pulleys 34 and 36 provided at opposing ends of belt 32, e.g., the direction from pulley 34 to pulley 36.

Conveyance device 30 may be capable of conveying container holding body 20 in both directions. Namely, in addition to conveyance direction DR1 described above, conveyance device 30 may also be capable of conveying container holding body 20 in the direction from the other to one of the pair of pulleys 34 and 36, which is opposite to conveyance direction DR1, e.g., the direction from pulley 36 to pulley 34. The conveyance direction of container holding body 20 by conveyance device 30 is configured to be switchable, and thus, the user using medicinal agent filling device 1 can select any one of the directions as conveyance direction DR1. As a result, in accordance with the situation of actual placement of medicinal agent filling device 1, container holding body 20 can be conveyed in more appropriate direction to fill the medicinal agent into container 26.

Conveyance device 30 is not limited to the belt conveyor. Conveyance device 30 may have any configurations as long as it can convey container holding body 20 in conveyance direction DR1. For example, conveyance device 30 may be configured such that a robot arm capable of making fine adjustments of the position in conveyance direction DR1 is included and this robot arm holds container holding body 20 and moves container holding body 20 in conveyance direction DR1.

The operation of medicinal agent filling device 1 having the aforementioned configuration will be described below. First, container holding body 20 holding containers 26 is arranged at a conveyance start position of conveyance device 30.

After container holding body 20 is arranged, conveyance of container holding body 20 by conveyance device 30 is started. Conveyance device 30 has a conveyance motor that is a motive power source for rotating any one of or both pulleys 34 and 36 and moving belt 32. By driving the conveyance motor, container holding body 20 placed on belt 32 is conveyed and starts to move.

FIG. 5 is a partial cross-sectional view showing a state in which container holding body 20 approaches a first supply position L1. Conveyance device 30 conveys container holding body 20, so that container holding body 20 moves along conveyance direction DR1 to the position at which the medicinal agent can be supplied from supply device 10 to container 26 held by container holding body 20. In the present specification, such arrangement of container holding body 20 that the medicinal agent can be supplied from supply device 10 to container 26 held by any one of the plurality of holding sections 22 is referred to as a supply position L. When container holding body 20 is staying at supply position L, container 26 that should be held by any one of the plurality of holding sections 22 is present at the position where the medicinal agent can be supplied from supply device 10.

Supply device 10 is provided with a discharge port 16. The medicinal agent to be supplied to container 26 is discharged from supply device 10 via discharge port 16. If container 26 is held by corresponding holding section 22 when container holding body 20 is staying at supply position L, this container 26 is arranged immediately below discharge port 16, and this container 26 can receive the medicinal agent falling from supply device 10 via discharge port 16 and the medicinal agent can be supplied to this container 26. It is to be noted that even when container holding body 20 is staying at supply position L, container 26 cannot receive the medicinal agent falling from supply device 10 if container 26 is not held by corresponding holding section 22, and thus, the medicinal agent is not supplied from supply device 10 to container 26.

Container holding body 20 in the present embodiment described with reference to FIG. 2 has three holding sections 22 and can hold a total of three containers 26 in respective holding sections 22. Therefore, there are supply positions L corresponding to three containers 26, respectively. Supply position L at which the medicinal agent can be supplied to container 26 to be held by holding section 22a is defined as first supply position L1. Supply position L at which the medicinal agent can be supplied to container 26 to be held by holding section 22b is defined as a second supply position L2. Supply position L at which the medicinal agent can be supplied to container 26 to be held by holding section 22c is defined as a third supply position L3.

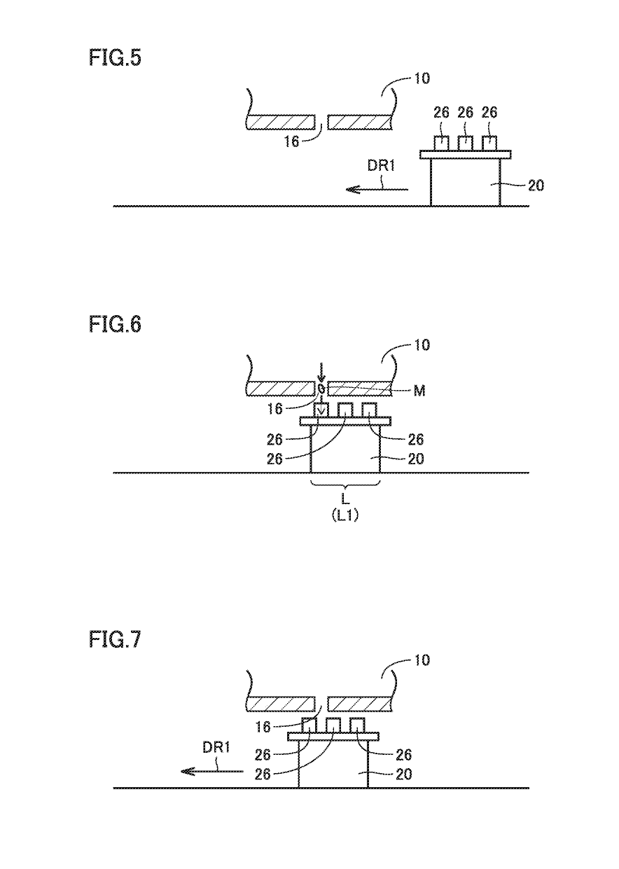

FIG. 6 is a partial cross-sectional view showing a state in which container holding body 20 is located at first supply position L1. When container holding body 20 reaches first supply position L1, the conveyance of container holding body 20 by conveyance device 30 is suspended and container holding body 20 no longer moves. In the state shown in FIG. 6, container holding body 20 is staying at the position where the medicinal agent can be supplied from supply device 10 to container 26 held by holding section 22 located on the most downstream side in conveyance direction DR1, of the plurality of holding sections 22 (i.e., holding section 22 farthest from the conveyance start position and closest to a conveyance end position, that is, holding section 22a of three holding sections 22 shown in FIG. 2). Container 26 held by holding section 22a is staying at the position where upper opening 28 thereof faces discharge port 16 of supply device 10. In this state, the medicinal agent is supplied to container 26 held by holding section 22a. Supply device 10 has a supply motor that is a motive power source for performing the operation of discharging the medicinal agent from supply device 10. By driving the supply motor, a medicinal agent M is discharged from supply device 10. Medicinal agent M is discharged and falls from supply device 10 via discharge port 16 formed in supply device 10, and is supplied into container 26 held by holding section 22a, via upper opening 28 formed in container 26. In this manner, the prescribed type and quantity of medicinal agent M is filled into container 26 held by holding section 22a.

When the supply of the medicinal agent to container 26 is completed, the conveyance of container holding body 20 by conveyance device 30 is restarted. FIG. 7 is a partial cross-sectional view showing a state in which container holding body 20 approaches a second supply position L2. Conveyance device 30 conveys container holding body 20, so that container holding body 20 moves from first supply position L1 to second supply position L2 along conveyance direction DR1. When container holding body 20 reaches the next supply position, i.e., second supply position L2 in this case, the conveyance of container holding body 20 is suspended.

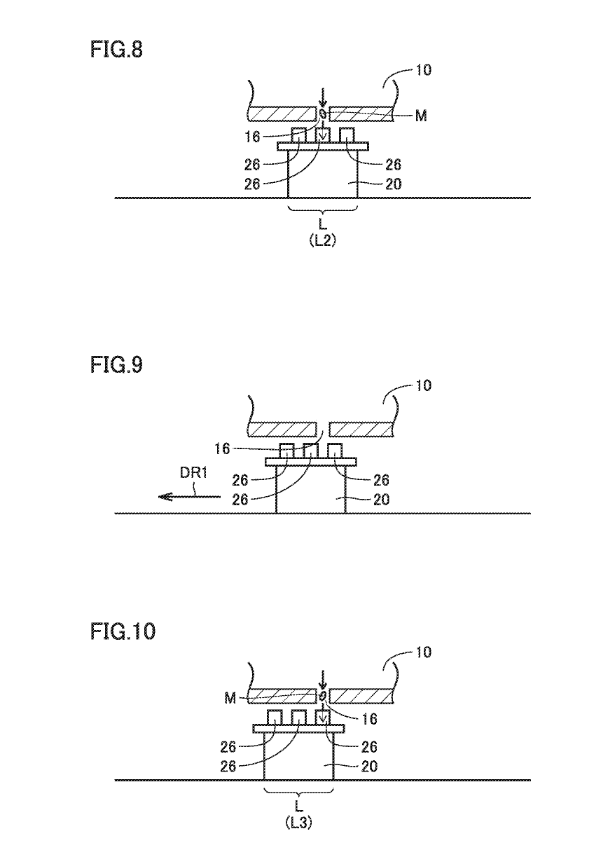

FIG. 8 is a partial cross-sectional view showing a state in which container holding body 20 is located at second supply position L2. In the state shown in FIG. 8, container holding body 20 is staying at second supply position L2 where the medicinal agent can be supplied from supply device 10 to container 26 held by the second holding section 22 from the downstream side in conveyance direction DR1, of the plurality of holding sections 22 (i.e., holding section 22b of three holding sections 22 shown in FIG. 2). Container 26 held by holding section 22b is staying at the position where upper opening 28 thereof faces discharge port 16 of supply device 10.

In this state, the medicinal agent is supplied to container 26 held by holding section 22b. By driving the supply motor, medicinal agent M is discharged from supply device 10. Medicinal agent M is discharged and falls from supply device 10 via discharge port 16 formed in supply device 10, and is supplied into container 26 held by holding section 22b, via upper opening 28 formed in container 26. In this manner, the prescribed type and quantity of medicinal agent M is filled into container 26 held by holding section 22b.

When the supply of the medicinal agent to container 26 is completed, the conveyance of container holding body 20 by conveyance device 30 is restarted. FIG. 9 is a partial cross-sectional view showing a state in which container holding body 20 approaches a third supply position L3. Conveyance device 30 conveys container holding body 20, so that container holding body 20 moves from second supply position L2 to third supply position L3 along conveyance direction DR1. When container holding body 20 reaches the next supply position, i.e., third supply position L3 in this case, the conveyance of container holding body 20 is suspended.

FIG. 10 is a partial cross-sectional view showing a state in which container holding body 20 is located at third supply position L3. In the state shown in FIG. 10, container holding body 20 is staying at third supply position L3 where the medicinal agent can be supplied from supply device 10 to container 26 held by the third holding section 22 from the downstream side in conveyance direction DR1, of the plurality of holding sections 22 (i.e., holding section 22c of three holding sections 22 shown in FIG. 2). Container 26 held by holding section 22c is staying at the position where upper opening 28 thereof faces discharge port 16 of supply device 10.

In this state, the medicinal agent is supplied to container 26 held by holding section 22c. By driving the supply motor, medicinal agent M is discharged from supply device 10. Medicinal agent M is discharged and falls from supply device 10 via discharge port 16 formed in supply device 10, and is supplied into container 26 held by holding section 22c, via upper opening 28 formed in container 26. In this manner, the prescribed type and quantity of medicinal agent M is filled into container 26 held by holding section 22c.

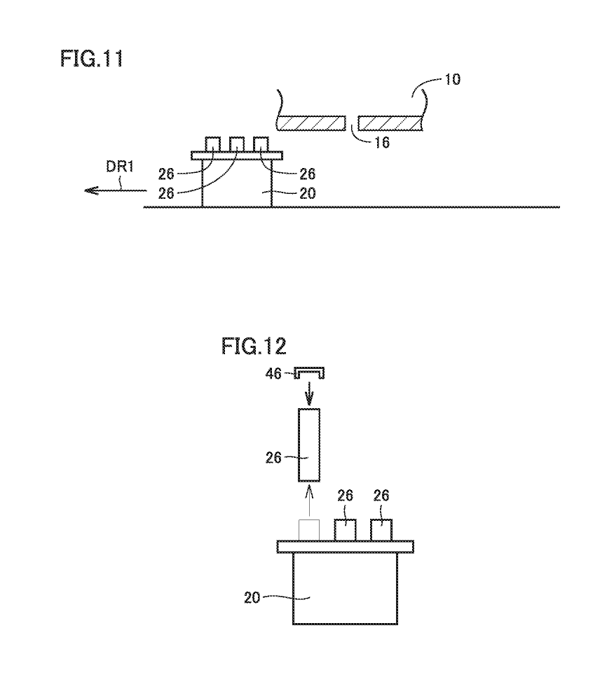

When the supply of the medicinal agent to container 26 is completed, the conveyance of container holding body 20 by conveyance device 30 is restarted. FIG. 11 is a partial cross-sectional view showing a state in which container holding body 20 leaves supply position L. Conveyance device 30 conveys container holding body 20, so that container holding body 20 moves along conveyance direction DR1 so as to leave third supply position L3. When container holding body 20 reaches the conveyance end position, the conveyance of container holding body 20 ends. In this manner, the operation of medicinal agent filling device 1 for supplying the medicinal agent from supply device 10 to containers 26 is completed.

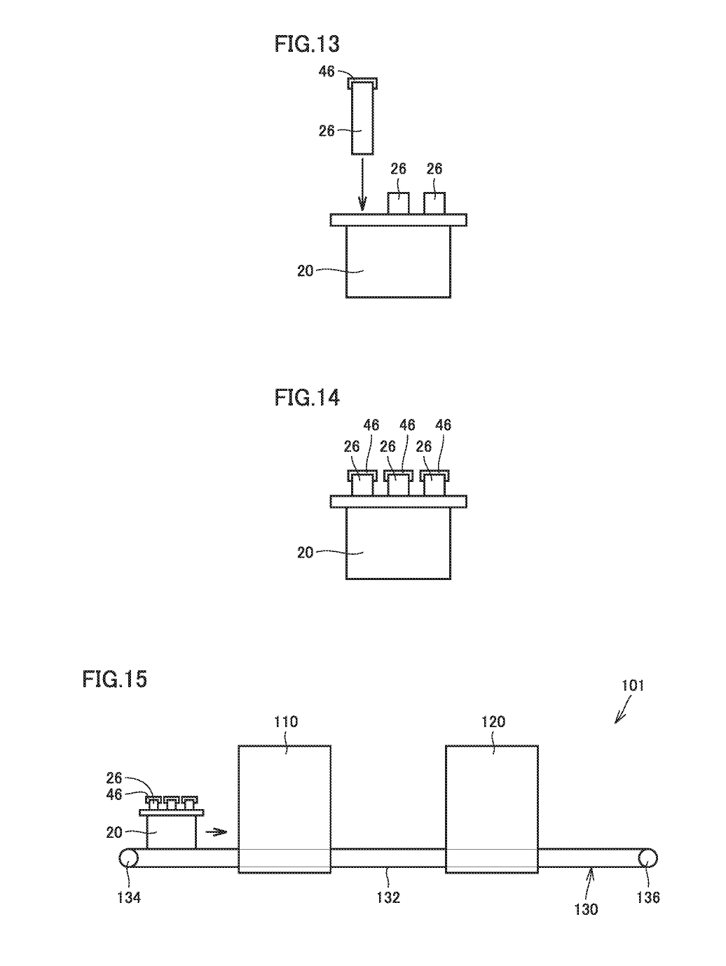

When the filling of medicinal agent M into containers 26 is completed, then in step (S30) shown in FIG. 1, sealing for closing upper opening 28 of each container 26 is performed. FIG. 12 is a side view showing a state immediately before one container 26 is sealed. FIG. 13 is a side view showing a state in which one container 26 has been sealed. FIG. 14 is a side view showing a state in which all containers 26 have been sealed.

Container 26 is sealed in order to prevent the filled medicinal agent from spilling from container 26 to the outside after the filling of the medicinal agent into container 26 ends. In the present embodiment, as shown in FIG. 12, container 26 having been filled with the medicinal agent is temporarily taken out from container holding body 20, and the end of container 26 on the side where upper opening 28 is formed is covered with a sealing body 46, and sealing body 46 is fixed to container 26. As a result, as shown in FIG. 13, a structure including integrated container 26 and sealing body 46 is formed, and a state of a hollow interior space of this structure being filled with medicinal agent M is attained.

Container 26 and sealing body 46 may be integrally engaged with each other by the screw-shaped engagement formed on an outer circumferential surface of container 26 and on an inner circumferential surface of sealing body 46. In the sealing work, container 26 and sealing body 46 may be integrally fixed so as to form an enclosed space. However, container 26 and sealing body 46 may form a state of engagement of container 26 and sealing body 46 to such an extent that spilling of the medicinal agent from container 26 can be prevented.

Container 26 having sealing body 46 fixed thereto is again fitted into container holding body 20, and sealed container 26 is held by container holding body 20. When container holding body 20 holds the plurality of containers 26, the plurality of containers 26 are sequentially taken out from container holding body 20, sealed and then housed again in container holding body 20 one by one. In this manner, a state of all containers 26 being sealed and held by container holding body 20 as shown in FIG. 14 is attained. Instead of the process of temporarily taking out container 26 from container holding body 20 and sealing container 26, container 26 may be sealed, with container 26 being held by container holding body 20. In this case, the plurality of containers 26 may be sequentially sealed one by one, or the plurality of containers 26 may be simultaneously sealed.

The work for sealing container 26 may be performed manually, or may be performed automatically by using a device for the sealing work.

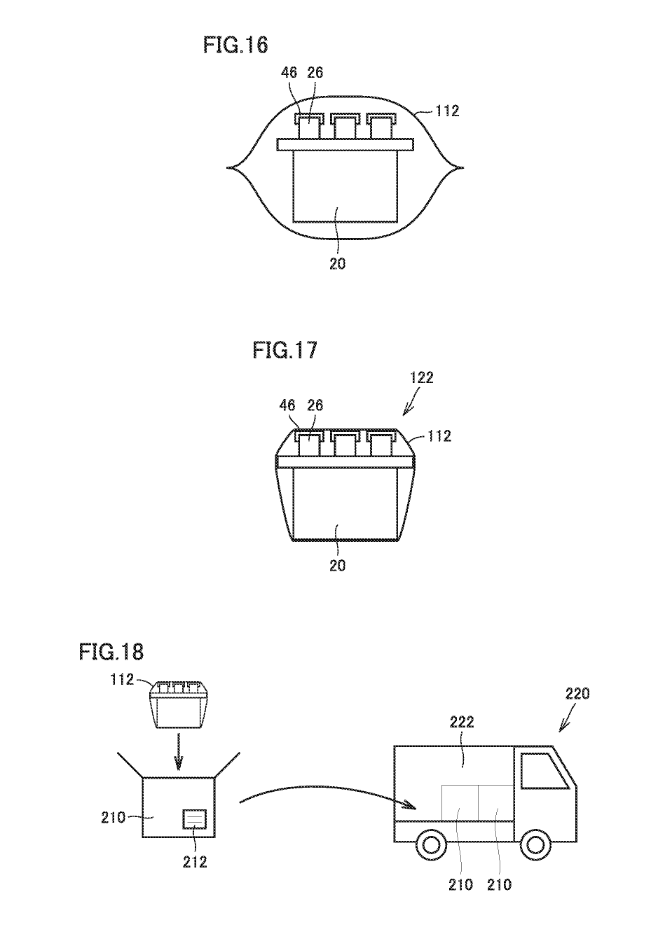

When the sealing of containers 26 is completed, then in step (S40) shown in FIG. 1, containers 26 held by container holding body 20 and container holding body 20 are wrapped into one package. FIG. 15 is a side view showing a schematic configuration of a wrapping device 101. FIG. 16 is a side view showing container holding body 20 after a film 112 is applied. FIG. 17 is a side view showing container holding body 20 after wrapping is completed.

Wrapping device 101 shown in FIG. 15 is a device for integrally wrapping containers 26 and container holding body 20 holding containers 26. Wrapping device 101 shrink-wraps containers 26 and container holding body 20 to form a wrapped product 122 as one package. Wrapping device 101 has: a film wrapping portion 110 for wrapping containers 26 and container holding body 20, which are a wrapped object, in film 112; a heating portion 120 for heating the wrapped object wrapped in film 112; and a conveying portion 130 for conveying the wrapped object.

Conveying portion 130 is a known belt conveyor having a belt 132 and a pair of pulleys 134 and 136. Container holding body 20 is placed on a placement surface on the upper side of belt 132. By movement of belt 132 with rotational motion of pulleys 134 and 136, container holding body 20 placed on belt 132 is conveyed. Container holding body 20 conveyed by conveying portion 130 passes through film wrapping portion 110 and heating portion 120 in this order, so that container holding body 20 is shrink-wrapped.

In film wrapping portion 110, the wrapped object conveyed by conveying portion 130 is arranged within bag-like film 112. For example, a strip-like film may be wrapped around the wrapped object to form bag-like film 112. Alternatively, the wrapped object may be arranged within bag-like film 112 by inserting the wrapped object into a tube-like film and then melt-cutting the opposing ends of the tube-like film. FIG. 16 shows a state in which the entire outer circumference of container holding body 20 and containers 26 held by container holding body 20 is covered with film 112 at the exit of film wrapping portion 110.

Thereafter, the wrapped object wrapped in film 112 passes through heating portion 120. In heating portion 120, heat-treatment for heating film 112 is performed. Film 112 shrinks by receiving the heat in heating portion 120. Shrunk film 112 comes into close contact with the surfaces of container holding body 20, containers 26 and sealing bodies 46, which are the wrapped object. In this manner, as shown in FIG. 17, wrapped product 122 is formed, in which container holding body 20 holding containers 26 sealed by sealing bodies 46 is wrapped in film 112.

FIG. 18 is a view schematically showing packing and shipment of container holding body 20. Containers 26 and container holding body 20 wrapped into one package are then packed in step (S50) shown in FIG. 1. For example, as shown on the left side in FIG. 18, packing may be performed by preparing a packing box 210 and housing wrapped product 122 in packing box 210, and then closing packing box 210. A label 212 describing the necessary information such as an address and a name of a destination of shipment of the medicinal agent is affixed onto an outer surface of packing box 210. Packing box 210 may be a cardboard box or a case made of resin.

When the packing ends, the medicinal agent is finally shipped in step (S60) shown in FIG. 1. For example, as shown on the right side in FIG. 18, packing box 210 is loaded onto a cargo bed 222 of a truck 220 and the medicinal agent is shipped to a designated place such as a hospital.

According to the method for handling the medicinal agent container of the present embodiment described above, container holding body 20 has the plurality of holding sections 22 and is provided such that each holding section 22 can hold container 26. Thus, by filling an appropriate type and an appropriate quantity of medicinal agent into one container 26 or each of the plurality of containers 26 held by container holding body 20, an optimum unit in terms of the type and/or quantity of medicinal agent can be managed as one unit.

For example, it is possible to fill different types of medicinal agents into a plurality of containers 26 held by one container holding body 20, respectively, and put the plurality of types of medicinal agents to be administered to one patient together in one container holding body 20. This facilitates matching between a prescription and the medicinal agents before the medicinal agents are handed to the patient. In addition, for example, when a pharmacy or a hospital is replenished with a medicinal agent that is in short supply at the present moment, one or a plurality of container holding bodies 20 are allotted to each pharmacy or each hospital, and thereby, matching of the type and the quantity of lacking medicinal agent can be easily performed. As a matter of course, in addition to allotting container holding body 20/container holding bodies 20 to each hospital, container holding body 20/container holding bodies 20 may be allotted to each hospital ward or each hospital room to appropriately manage supply of the medicinal agents.

When the medicinal agent is filled into containers 26, container holding body 20 sequentially stops at first to third supply positions L1, L2 and L3 by conveyance device 30. Container holding body 20 can be reliably stopped at the positions where the medicinal agent can be supplied from supply device 10 to container 26, and the medicinal agent can be sequentially supplied to the plurality of containers 26 automatically. Since container holding body 20 holding containers 26 capable of being filled with the medicinal agent is conveyed by conveyance device 30 and the medicinal agent can be automatically supplied from supply device 10 to containers 26, the operator's time and effort when the operator fills the medicinal agent into containers 26 can be significantly reduced.

Container holding body 20 is used when the medicinal agent is filled into containers 26, and containers 26 held by container holding body 20 and container holding body 20 are wrapped into one package and shipped. The same container holding body 20 can be used as the container holding body used to hold containers 26 at the time of filling the medicinal agent and as the container holding body used to hold containers 26 at the time of shipment. Since the common container holding body can be used in the plurality of steps, cost reduction can be achieved. In addition, it is unnecessary to transfer container 26 having been filled with the medicinal agent to another container holding body. Therefore, mix-up of the medicinal agent at the time of shipment can be prevented, and thus, incorrect shipment of the medicinal agent can be avoided and the appropriate type and quantity of medicinal agent can be reliably shipped to the intended destination of shipment.

If the plurality of containers 26 are set in container holding body 20, and the medicinal agent is filled into these plurality of containers 26 at one time, and the plurality of containers 26 are wrapped into one package and shipped, it is possible to more remarkably obtain the effect of allowing more reliable shipment of the medicinal agent by using the common container holding body at the time of filling the medicinal agent and at the time of shipment.

Due to wrapping by shrink-wrapping, containers 26 and container holding body 20 can be reliably lumped together and wrapped without becoming separated.

In the foregoing description, container holding body 20 is provided with three holding sections 22 and container holding body 20 can simultaneously hold a maximum of three containers 26. However, the present invention is not limited to this configuration. Container holding body 20 may be able to have a larger number of holding sections 22 and simultaneously hold a larger number of containers 26 in accordance with the increase in the number of holding sections 22. A plurality of types of container holding bodies 20 having the different number of holding sections 22 may be prepared and container holding body 20 may be selectable as appropriate by the user operating medicinal agent filling device 1.

While the embodiment of the present invention has been described above, it should be understood that the embodiment disclosed herein is illustrative and not limitative in any respect. The scope of the present invention is defined by the terms of the claims, rather than the description above, and is intended to include any modifications within the scope and meaning equivalent to the terms of the claims.

### REFERENCE SIGNS LIST

1 medicinal agent filling device, 10 supply device, 16 discharge port, 20 container holding body, 21 main body portion, 22, 22a, 22b, 22c holding section, 23 flange portion, 26 container, 28 upper opening, 30 conveyance device, 32, 132 belt, 34, 36, 134, 136 pulley, 46 sealing body, 101 wrapping device, 110 film wrapping portion, 112 film, 120 heating portion, 122 wrapped product, 130 conveying portion, 210 packing box, 212 label, 220 truck, 222 cargo bed, DR1 conveyance direction, L supply position, L1 first supply position, L2 second supply position, L3 third supply position, M medicinal agent.

1. A method for handling a medicinal agent container, comprising the steps of:
setting a container in a container holding body capable of holding a plurality of containers, the container being capable of being filled with a medicinal agent;
filling the medicinal agent of interest into the container held by the container holding body;
sealing the container; and
wrapping the container held by the container holding body and the container holding body into one package.

2. The method for handling a medicinal agent container according to claim 1, wherein
in the step of filling, by a conveyance device for conveying the container holding body, the container holding body is moved to a supply position at which the medicinal agent can be supplied to the container held by the container holding body.

3. The method for handling a medicinal agent container according to claim 1, wherein
in the step of wrapping, the container and the container holding body are shrink-wrapped.

4. The method for handling a medicinal agent container according to claim 1, further comprising the step of shipping the container and the container holding body wrapped into one package.

5. The method for handling a medicinal agent container according to claim 1, wherein
in the step of setting, more than one container is set in the container holding body.
